(19) United States
(12) Patent Application Publication
(10) Pub. No.: US 2010/0079437 A1
(43) Pub. Date: Apr. 1, 2010

(54) Source driver circuit having bias circuit which produces bias current based on vertical synchronizing signal and method of controlling the same

(75) Inventor: Fumio Tonomura, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/585,439

(22) Filed: Sep. 15, 2009

(30) Foreign Application Priority Data
Sep. 26, 2008 (JP) 2008-248512

(51) Int. Cl. G09G 5/00; G09G 3/36

(52) U.S. Cl. 345/211; 345/92

(57) ABSTRACT

A source driver circuit includes a bias circuit supplying a bias current corresponding to a control signal, and a source amplifier circuit supplying a voltage corresponding to the bias current to a pixel element in a display panel. The source driver circuit further includes a controller circuit generating the control signal according to the frequency of a vertical synchronizing signal for the display panel.

### INCORPORATION BY REFERENCE

This application is based upon and claims the benefit of priority from Japanese Patent Application No. 2008-248512 which was filed on Sep. 26, 2008, the disclosure of which is incorporated herein in its entirety by reference.

### BACKGROUND OF THE INVENTION

1. Field of the Invention

The present invention relates to a source driver circuit and a method for controlling the source driver circuit, and more particularly, to a source driver circuit for driving a display panel and a method for controlling the source driver circuit.

2. Description of Related Art

Liquid crystal panel driving ICs for cellular phones contain a source driver circuit that drives TFTs in a liquid crystal panel, a gate driver circuit (or a gate driver driving circuit if the gate driver circuit is provided in the liquid crystal panel), and a timing controller circuit that controls the source driver circuit and the gate driver circuit. The timing controller is a circuit that generates a display timing based on an external display clock and an external synchronizing signal and performs control corresponding to a setting written, via a serial interface, to a register contained in the driver.

It is important for each relevant company to improve the display quality of the panel of the cellular phone and to save power for the cellular phone in order to differentiate the company from the others. Furthermore, to deal flexibly with various panel designs, the number of control lines connecting a motherboard in the cellular phone and the liquid crystal panel is desirably minimized. Thus, some cellular phone makers provide cellular phones without a serial interface for controlling display panel driving ICs.

Furthermore, the frame frequency (image display cycle) of the cellular phone is often changed. For example, in order to save power required in a standby state, the number of display colors is reduced to decrease the frame frequency (image display cycle). The frame frequency may be temporarily increased to prevent unwanted sound from being made during a call by the possible resonance between the frame frequency and the housing of the phone.

Thus, to allow the display panel driving ICs to be used for general applications, it is important to ensure appropriate display image quality and appropriate power consumption without the need to allow the phone side to perform control through the serial interface or the like, in any use situations, for example, even if the frame frequency is changed during operation.

FIG. 8 shows the configuration of a common source driver circuit 10 of a related art. The source driver circuit 10 has a bias circuit 11, a controller circuit 12, and a source amplifier circuit 13.

The bias circuit 11 has PMOS transistors MP1 to MP6, NMOS transistors MN1 and MN2, and a current source 11a. The PMOS transistors MP1 to MP4 serve as a current mirror circuit in which the PMOS transistor MP1 serves as an input. Currents flowing through the PMOS transistors MP1 to MP4 are denoted by I1 to I4, respectively. The MOS transistors MP5 and MP6 are switches that prevent the currents I3 and I4 from flowing. A current corresponding to the sum of the currents I2, I3, and I4 flows through the NMOS transistor MN1. The NMOS transistors MN1 and MN2 serve as a current mirror circuit in which the NMOS transistor MN1 serves as an input. Thus, a current corresponding to a current flowing through the NMOS transistor MN1 flows through the NMOS transistor MN2.

The controller circuit 12 has a serial interface circuit 12a and a register 12b. Circuits denoted by reference numerals LS1 and LS2 are level shifters. Circuits denoted by reference numerals IV1 and IV2 are inverter buffers. The serial interface circuit 12a retrieves a serial control signal S1 from the cellular phone side. The register 12b has a predetermined number of bits, for example, k (natural number) bits, to store retrieved information as ADJ[k−1:0]. For example, if the register 12b has 2 bits, then the information is stored as ADJ[1:0]. A setting signal corresponding to ADJ[k−1:0] in the register 12b controllably turns on and off the PMOS transistors MP5 and MP6. In the example, for simplification of illustration, the register 12b is assumed to have 2 bits.

A source amplifier 13 has amplifiers AMP1 to AMPn. The amplifiers AMP1 to AMPn output gradation voltages corresponding to input data D1 to Dn to output terminals OT1 to OTn. FIG. 8 shows only the bias circuit 11 and controller circuit 12 connected to the amplifier AMP1. Similarly configured circuits are connected to each of the other amplifiers AMP2 to AMPn.

The operation of the source driver circuit 10 is shown below. First, ADJ[1:0] is written to the register via the serial interface 12a. The ADJ[1:0], the value held in the register 12b, controllably turns on and off the PMOS transistors MP5 and MP6. Thus, a bias current supplied to the amplifier AMP1 changes according to the ADJ[1:0]. For example, if the ADJ[1:0] is “01”, the PMOS transistor MP6 is turned on, while the PMOS transistor MP5 is turned off. Thus, the amplifier AMP1 is supplied with a bias current corresponding to a current I2+I4. In this manner, the through rate and current consumption of the amplifier AMP1 are determined by the operating bias current corresponding to the value held in the ADJ[1:0] of the register 12b.

FIGS. 9A and 9B show the relationship between the bias current and each of the through rate and current consumption in the amplifier AMP1. As shown in FIG. 9A, the through rate decreases and increases consistently with the operating bias current, which change according to the ADJ[1:0]. The current consumption decreases and increases consistently with the operating bias current, which changes according to the ADJ[1:0].

Here, for a display panel with the same number of pixels, a high frame frequency reduces the time allowed for charging of a gradation voltage into one pixel capacity. Thus, an output voltage from the source amplifier 13 needs to reach a desired value quickly. That is, the through rate needs to be high. In contrast, a low frame frequency increases the time allowed for charging of a gradation voltage into one pixel capacity. Thus, a long time is allowed for the output voltage of the source amplifier 13 to reach the desired value. That is, the through rate may be low. Furthermore, the power consumption is desirably lower to the extent that appropriate image quality can be maintained. The through rate is desirably reduced if possible.

Thus, in the source driver circuit 10, when the frame frequency is changed, for example, from 60 Hz to 90 Hz, on the cellular phone side, the bias is set, via the serial interface, so as to increase the through rate. In contrast, when the frame frequency is changed from 90 Hz to 60 Hz, the bias is set, via the serial interface, so as to reduce the through rate. Thus, even with a change in frame frequency, the through rate and the current consumption can be set to appropriate values.

A technique disclosed in Patent Document (Japanese Patent Application Laid-Open No. 2003-66919) counts the number of clocks for a control input signal with a pulse width corresponding to display lines, from the rising edge to falling edge of the signal. A display panel driving device according to Patent Document generates a signal allowing the operating bias current of an amplifier to be switched between a high bias and a low bias.

### SUMMARY

As in the case of Patent Document, a circuit can be provided which counts the number of clocks for a control input signal (HSYNC or VSYNC) with the pulse width corresponding to the frame frequency, from the rising edge to falling edge of the signal, to allow the bias current to be switched according to the frame frequency. Such a source driver circuit 20 is shown in FIG. 10.

The source driver circuit 20 includes a controller circuit 22 corresponding to the controller circuit 12 in the source driver circuit 10 but configured differently from the controller circuit 12. For the remaining part of the configuration, the source driver circuit 20 is similar to the source driver circuit 10. The controller circuit 22 has an HSYNC_Low period counter 22a and a decoder 22b. The HSYNC Low period counter 22a counts the Low period of the horizontal synchronizing signal (HSYNC) from the phone side using a display clock signal (DOTCLK). The decoder 22b generates, from a counter value from the counter 22a, a signal of k bits (in FIG. 10, 2 bits) controllably turning on and off the PMOS transistors MP5 and MP6.

The source driver circuit 20 operates as follows. First, the horizontal synchronizing signal (HSYNC) and the display clock (DOTCLK) are input to the controller circuit 22 as a display signal. As the Low width of the HSYNC, a value predetermined according to the frame frequency is input. For example, for 60 Hz, the input Low width corresponds to 4 DOTCLKs, and for 90 Hz, the input Low width corresponds to 3 DOTCLKs.

The HSYNC_Low period counter 22a detects how many DOTCLKs correspond to the Low width of the input HSYNC. As shown in FIG. 11A, at a frame frequency of 60 Hz, the Low width corresponds to 4 DOTCLKs. As shown in FIG. 11B, at a frame frequency of 90 Hz, the Low width corresponds to 3 DOTCLKs. As shown in FIG. 11C, at a frame frequency of 40 Hz, the Low width corresponds to 5 DOTCLKs.

A counter value is input to the decoder 22b. A control signal ADJ[1:0] of k bits (in FIG. 12, 2 bits) is generated as shown in the table in FIG. 12. The subsequent operation is similar to that of the source driver circuit 10.

In the source driver circuit 10 in FIG. 8, every time the frame frequency is changed, the phone side needs to set, via the serial interface, the register value according to the change. This disadvantageously increases the burden of control on the phone side. Furthermore, some applications have no serial interface. In this case, the through rate needs to be set according to the highest of the frame frequencies included in use conditions. However, if the cellular phone is used with the settings unchanged at a low frame frequency, then the current consumption disadvantageously increases. When top priority is given to reduced power consumption and the through rate is set according to the frame frequency corresponding to a standard condition, if the cellular phone is used with the settings unchanged at the high frame frequency, then the through rate is insufficient. This may disadvantageously degrade image quality.

Furthermore, every time the frame frequency changes, the source driver circuit 20 also needs to be supplied with an HSYNC with a different Low width and the like by the phone side according to the change. This disadvantageously increases the burden of control on the phone.

A source driver circuit of an exemplary aspect includes a bias circuit supplying a bias current corresponding to a control signal, and a source amplifier circuit supplying a voltage corresponding to the bias current to a pixel element in a display panel. The source driver circuit includes a controller circuit generating the control signal according to a frequency of a vertical synchronizing signal for the display panel.

The exemplary aspect allows the bias current to be changed according to the frequency of the vertical synchronizing signal for the display panel.

The exemplary aspect enables a change in the frame frequency of the display panel to be automatically detected without using an external control circuit. Then, according to the result of the detection, the through rate and the current consumption can be adjusted to appropriate conditions.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a diagram showing an example of the configuration of a source driver circuit according to a first exemplary embodiment;

FIG. 2 is a diagram showing the output signal characteristics of components of a control circuit according to the first exemplary embodiment;

FIG. 3 is a diagram showing an example of the configuration of a source driver circuit according to a second exemplary embodiment;

FIG. 4 is a schematic diagram showing the relationship between a vertical synchronizing signal and a count value in a counter according to the second exemplary embodiment;

FIG. 5 is a table showing the relationship between the count value in the counter and a bias control signal according to the second exemplary embodiment;

FIG. 6 is a diagram showing an example of the configuration of a source driver circuit according to a third exemplary embodiment;

FIG. 7 is a diagram showing the output signal characteristics of components of a control circuit according to the third exemplary embodiment;

FIG. 8 is a diagram showing an example of the configuration of a source driver circuit of a related art;

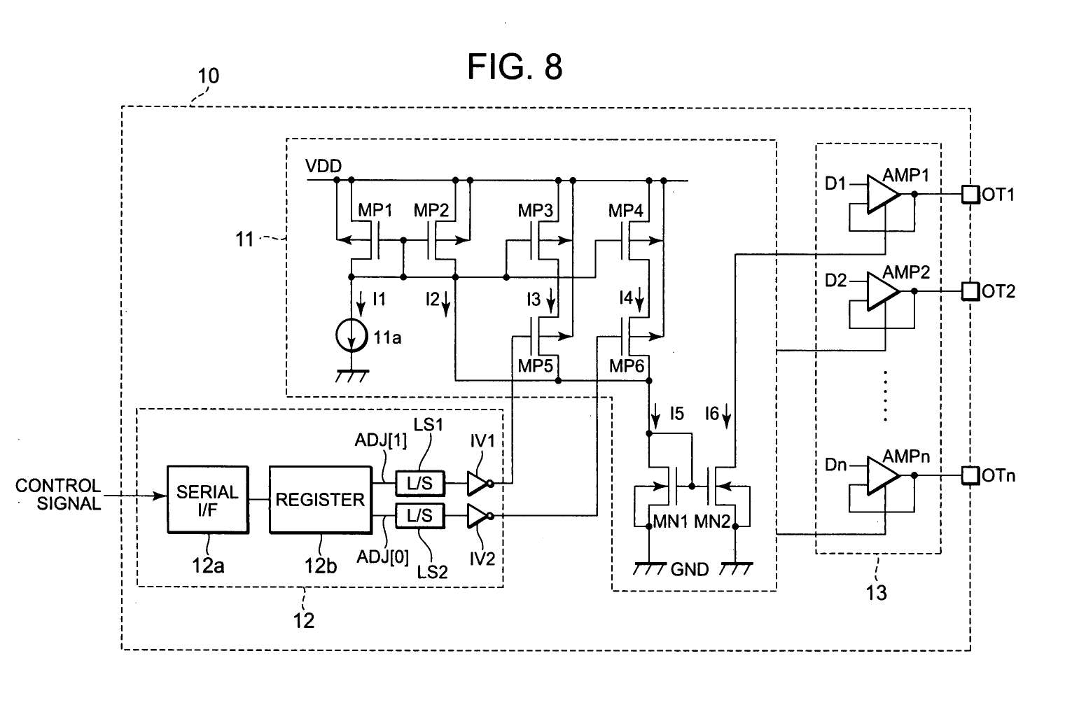

FIG. 9 is a graph showing the relationship between a bias control signal and each of a through rate and current consumption in the source driver circuit of the related art;

FIG. 10 is a diagram showing an example of the configuration of a source driver circuit of a related art;

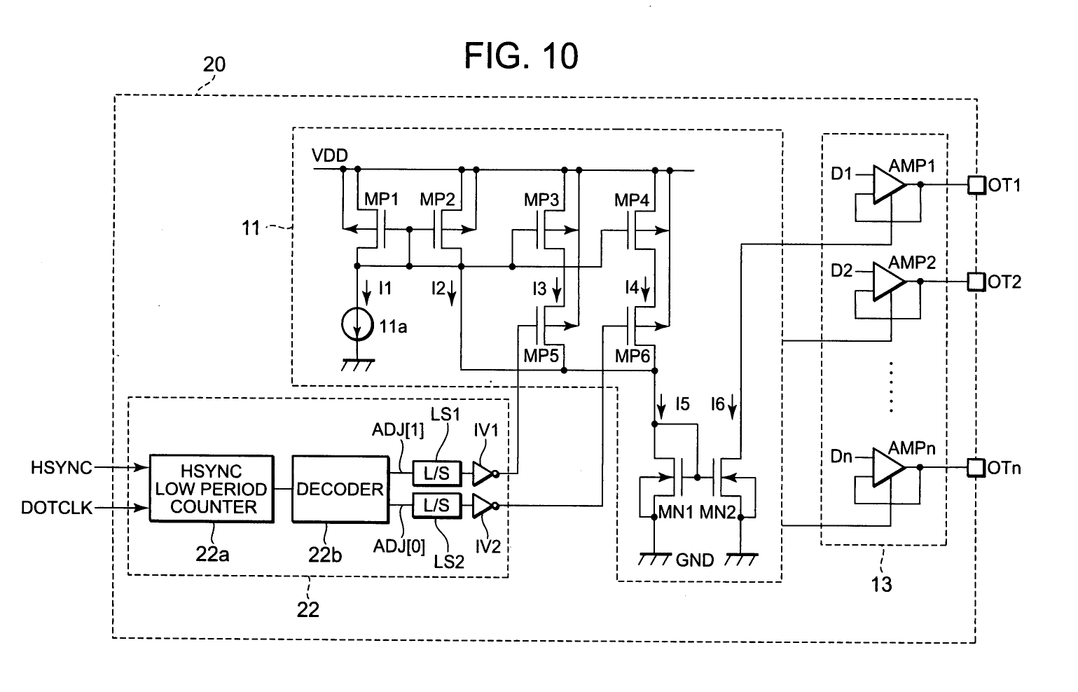

FIG. 11 is a schematic diagram showing the relationship between a control signal and a count value in a counter according to the related art; and

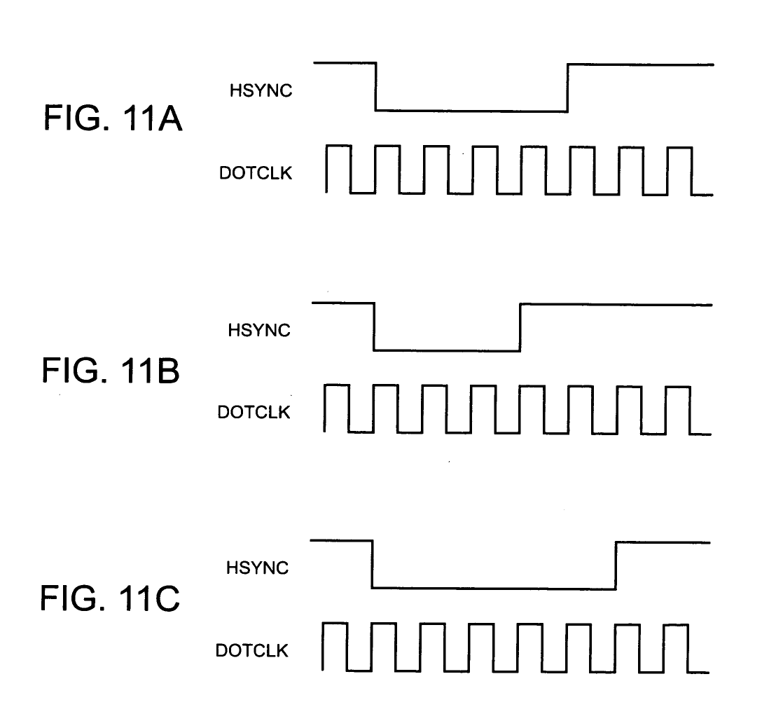

FIG. 12 is a table showing the relationship between a count value in a counter and a bias control signal according to the related art.

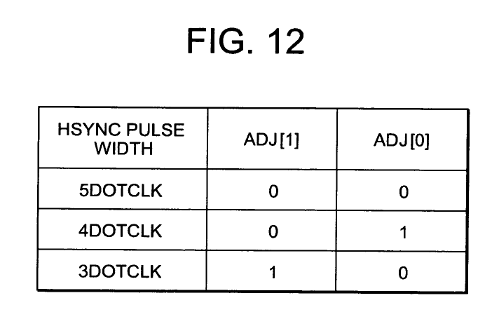

### DETAILED DESCRIPTION OF THE EXEMPLARY EMBODIMENTS

### First Exemplary Embodiment

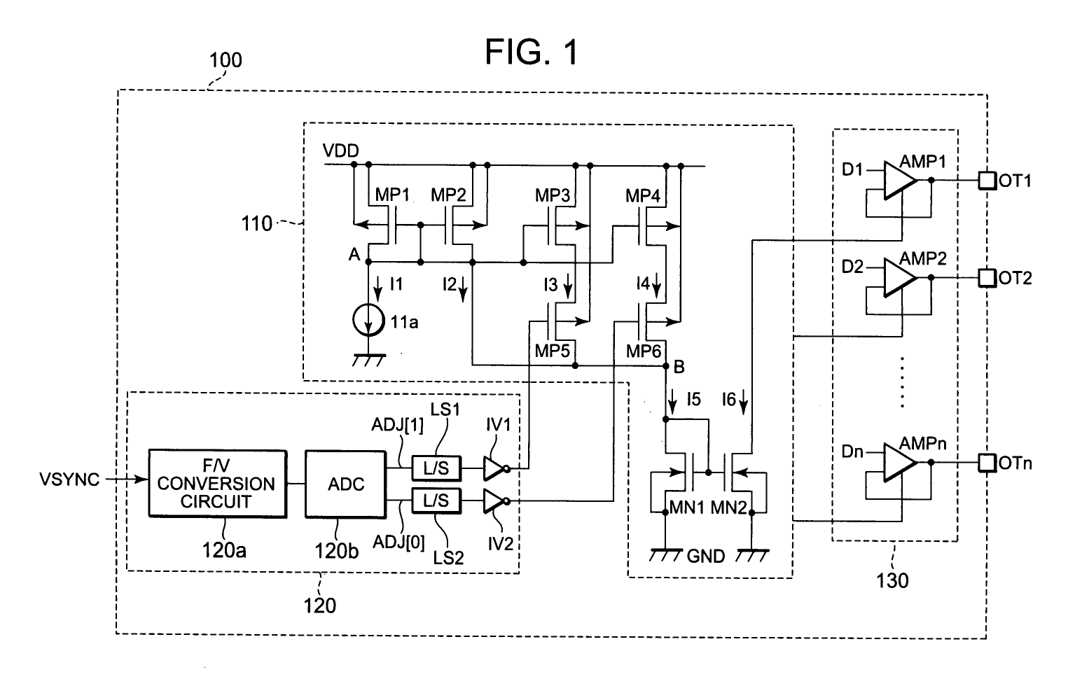

FIG. 1 shows an example of the configuration of a source driver circuit 100 according to a first exemplary embodiment. The source driver circuit 100 is used to drive TFTs in a liquid crystal display panel of a cellular phone. As shown in FIG. 1, the source driver circuit 100 has a bias circuit 110, a controller circuit 120, and a source amplifier circuit 130.

The bias circuit 110 has PMOS transistors MP1 to MP6, NMOS transistors MN1 and MN2, and a current source 11a.

The PMOS transistor MP1 has a source connected to a power supply voltage terminal VDD, and a drain and a gate connected to a node A. The PMOS transistor MP2 has a source connected to the power supply voltage terminal VDD, a drain connected to a node B, and a gate connected to a node A. The PMOS transistor MP3 has a source connected to the power supply voltage terminal VDD, a drain connected to the source of the PMOS transistor MP5, and a gate connected to the node A. The PMOS transistor MP4 has a source connected to the power supply voltage terminal VDD, a drain connected to the source of the PMOS transistor MP6, and a gate connected to the node A.

As is apparent from FIG. 1, the PMOS transistors MP1 to MP4 serve as a current mirror circuit in which the PMOS transistor MP1 serves as an input. Here, the PMOS transistor MP3 has a gate width double that of each of the PMOS transistors MP1, MP2, and MP4. The PMOS transistors MP1 to MP4 have an equal gate length. Thus, when currents flowing through the PMOS transistors MP1 to MP4 are denoted by I1 to I4, respectively, I1=I2=I4 and I3=2×I1.

The PMOS transistor MP5 has a source connected to the drain of the PMOS transistor MP3, a drain connected to the node B, and a gate connected to the controller circuit 120. The PMOS transistor MP6 has a source connected to the drain of the PMOS transistor MP4, a drain connected to the node B, and a gate connected to the controller circuit 120. The PMOS transistors MP5 and MP6 serve as switches that prevent the currents I3 and I4 from flowing.

A constant current source 11a has two terminals one of which is connected to the node A, with the other connected to a ground voltage terminal GND. An NMOS transistor MN1 has a drain and a gate connected to the node B and a source connected to the ground voltage terminal GND. An NMOS transistor MN2 has a drain connected to a source amplifier circuit 130, a source connected to the ground voltage terminal GND, and a gate connected to the node B. As is apparent from FIG. 1, the NMOS transistors MN1 and MN2 serve as a current mirror circuit in which the NMOS transistor MN1 serves as an input. Here, the NMOS transistors MN1 and MN2 have the same gate length and the same gate width. When currents flowing through the NMOS transistors MN1 and MN2 are denoted by I5 and I6, respectively, I5=I6. The current I6 is supplied as an operating bias current for an amplifier AMP1 in the source amplifier 130, described below. The power supply voltage terminal VDD provides a power supply voltage VDD. The ground voltage terminal GND provides a ground voltage GND.

The source amplifier 130 has amplifiers AMP1 to AMPn. The amplifiers AMP1 to AMPn output gradation voltages corresponding to input data D1 to Dn to output terminals OT1 to OTn, respectively. FIG. 1 shows only a bias circuit 110 and a controller circuit 120 connected to the amplifier AMP1. However, similarly configured bias circuits and controller circuits are also connected to each of the other amplifiers AMP2 to AMPn. However, the bias circuit 110 may be connected to all of the amplifiers AMP1 to AMPn. Here, the bias circuit 110 and controller circuit 120 connected to the amplifier AMP I will be mainly described.

The amplifier AMP1 has a low potential-side power supply terminal connected to the drain of the NMOS transistor MN2. Thus, the current I6 is supplied to the amplifier AMP1 as an operating bias current. An output voltage from the amplifier AMP1 changes according to the magnitude of the bias current. The speed of charging and discharging of the pixel capacity of a liquid crystal panel connected to the output terminal OT1 is controlled according to a change in the output voltage from the amplifier AMP1.

The controller circuit 120 has an F/V conversion circuit 120a, an ADC circuit 120b, level shifters LS1 and LS2, and buffers IV1 and IV2.

The F/V conversion circuit 120a retrieves a vertical synchronizing signal (VSYNC) from the cellular phone main body side (not shown in the drawings), converts the frequency into a voltage level, and then outputs the corresponding signal. The ADC circuit 120b is an analog/digital conversion circuit that generates a bias control signal ADJ[k−1:0] of k (natural number) bits according to the voltage level of the output signal from the F/V conversion circuit 120a and outputs the signal. In the first exemplary embodiment, for simplification of illustration and understanding of the invention, the bias control signal ADJ[k−1:0] is a 2-bit bias control signal ADJ[1:0].

The level shifters LS1 and LS2 convert the potential levels of the bias control signals ADJ[1] and ADJ[0], each of which has a value falling within a predetermined voltage range. The buffers Iv1 and Iv2 buffers output signals from the level shifters LS1 and Ls2. Output terminals of the buffers Iv1 and Iv2 are connected to the gates of the PMOS transistors MP5 and MP6, respectively. Thus, the PMOS transistors MP5 and MP6 are controllably turned on and off according to the value of the bias control signal ADJ[1:0].

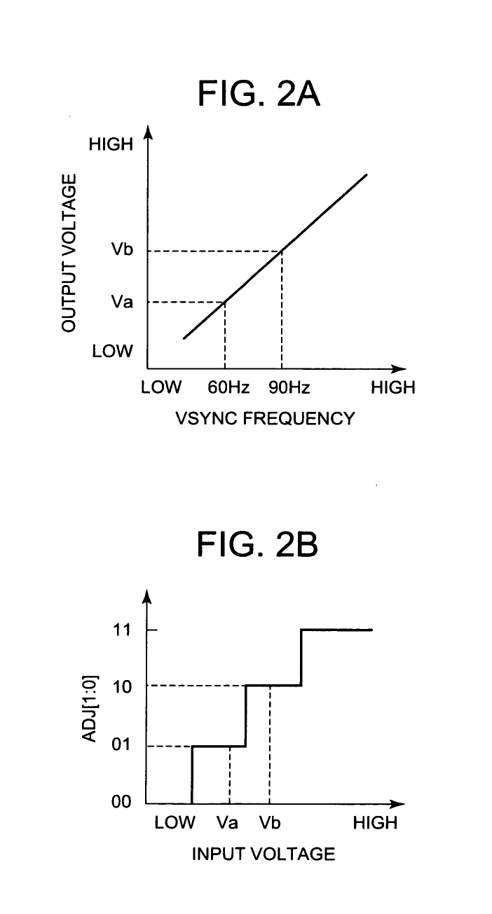

The operation of the source driver circuit 100 will be described below. FIG. 2A shows the relationship between the input vertical synchronizing signal VSYNC to and an output voltage from the F/V conversion circuit 120a. FIG. 2B shows the relationship between an input voltage to and the bias control signal ADJ[1:0] from the ADC circuit 120b.

First, the vertical synchronizing signal VSYNC from the cellular phone main body is input to the controller circuit 120 as a display signal. The vertical synchronizing signal VSYNC is input to the F/V conversion circuit 120a. F/V conversion circuit 120a outputs a voltage corresponding to the frequency of the vertical synchronizing signal VSYNC, for example, as shown in FIG. 2A. The output signal from the F/V conversion circuit 120a is input to the ADC circuit 120b, which thus generates a 2-bit bias control signal ADJ[1:0] corresponding to the input voltage, for example, as shown in FIG. 2B. In the first exemplary embodiment, the bias control signal generated by the ADC circuit 120b has 2 bits as described above. However, the input signal to the ADC circuit 120b may further be sampled at a plurality of gradations to generate a k-bit bias control signal, for example, ADJ[k−1:0]. In this case, the number of transistors provided in the bias circuit 110 needs to be increased according to the bias control signal ADJ[k−1] to ADJ[0].

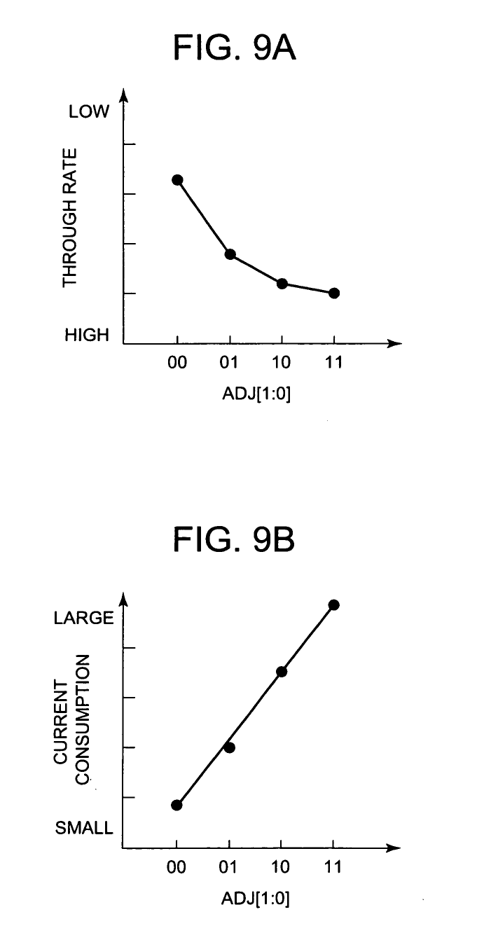

If the ADJ[1:0] generated by the ADC circuit 120b is “00”, then the PMOS transistors MP5 and MP6 are turned off. Thus, as a current I5, the current I2 with the same current value as that of the current I1 flows. Consequently, the amplifier AMP1 is supplied with a bias current I6 with the same current value as that of the current I1. If the ADJ[1:0] generated by the ADC circuit 120b is “01”, then the PMOS transistor MP5 is turned off, while the PMOS transistor MP6 is turned on. Thus, the current I5 has a current value equal to the sum of the currents I2 and I4. Consequently, the amplifier AMP1 is supplied with the bias current I6 having a current value double that of the current I1. If the ADJ[1:0] generated by the ADC circuit 120b is “10”, then the PMOS transistor MP5 is turned on, while the PMOS transistor MP6 is turned off. Thus, the current I5 has a current value equal to the sum of the currents I2 and I3. Consequently, the amplifier AMP1 is supplied with the bias current I6 having a current value triple that of the current I1. If the ADJ[1:0] generated by the ADC circuit 120b is “11”, then the PMOS transistors MP5 and MP6 are turned on. Thus, the current I5 has a current value equal to the sum of the currents I2, I3, and I4. Consequently, the amplifier AMP1 is supplied with the bias current I6 having a current value four times as large as that of the current I1. Therefore, the relationship between the value of the ADJ[1:0] and the through rate and the current consumption is similar to that shown in FIG. 9.

Thus, when the frame frequency of the liquid crystal panel is changed, for example, from 60 Hz to 90 Hz, on the cellular phone main body side, the frequency of the vertical synchronizing signal VSYNC is also changed from 60 Hz to 90 Hz. Consequently, the output voltage of the F/V conversion circuit 120a rises compared to that obtained at a frame frequency of 60 Hz.

For example, as shown in FIG. 2A, when the vertical synchronizing signal VSYNC has a frequency of 60 Hz, the F/V conversion circuit 120a outputs a voltage Va. The voltage Va is input to the ADC circuit 120b, which outputs the bias control signal ADJ[1:0] of “01”. Here, when the frequency of the vertical synchronizing signal VSYNC is changed from 60 Hz to 90 Hz as described above, the F/V conversion circuit 120a outputs a voltage Vb. The ADJ[1:0] changes to “10”. This increases the bias current I6 supplied to the amplifier AMP1. Consequently, the through rate of the amplifier AMP1 is set so as to be increased. In contrast, when the vertical synchronizing signal VSYNC is changed from 90 Hz to 60 Hz, the output voltage from the F/V conversion circuit 120a decreases from Vb to Va. Thus, the bias control signal ADJ[1:0] changes from “10” to “01”. Consequently, the through rate of the amplifier AMP1 is set so as to be reduced.

As described above, if the frame frequency of the liquid panel, that is, the frequency of the vertical synchronizing signal VSYNC, changes, then the source driver circuit 100 according to the first exemplary embodiment itself can automatically detect the change in frequency. Then, according to the result of the detection, the source driver circuit 100 can adjust the through rate and current consumption of the source amplifier 130 to the appropriate conditions. That is, if the frame frequency increases and the source amplifier 130 needs to provide a high through rate, then the bias current is increased to raise the through rate. In contrast, if the frame frequency decreases and the source amplifier 130 needs to provide a low through rate, then the bias current can be reduced to decrease the through rate and thus current consumption. Furthermore, the cellular phone main body side does not particularly require, for example, a control circuit controlling the source driver circuit 100. Thus, also on the cellular phone main body side, the present configuration enables the number of steps of designing circuits, the scale of the circuits, the current consumption, and the like to be reduced.

### Second Exemplary Embodiment

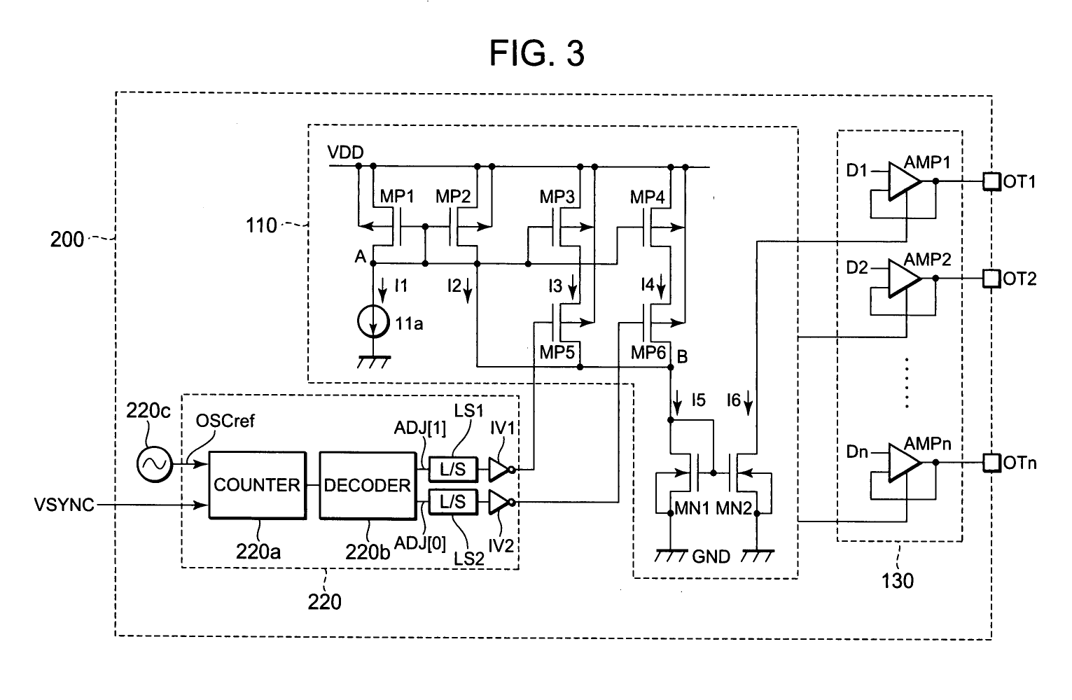

FIG. 3 shows an example of the configuration of a source driver circuit 200 according to a second exemplary embodiment. As shown in FIG. 3, the source driver circuit 200 has a bias circuit 110, a controller circuit 220, and a source amplifier circuit 130. The configurations and operations of the bias circuit 110 and source amplifier circuit 130 are similar to those in the first exemplary embodiment and will thus not be described below. The second exemplary embodiment differs from the first exemplary embodiment only in the configuration of the controller circuit 220. This will mainly be described.

The controller circuit 220 has a counter 220a, a decoder 220b, and a reference oscillation circuit 220c.

The reference oscillation circuit 220c generates a reference frequency signal with a frequency OSCref. The counter 220a retrieves a vertical synchronizing signal (VSYNC) from a cellular phone main body side (not shown in the drawings). The counter 220a then counts the period of the vertical synchronizing signal (VSYNC) based on the frequency of the reference frequency signal generated by the reference oscillation circuit 220c. According to the value counted by the counter 220a, the decoder 220b generates and outputs a bias control signal ADJ[k−1:0] of k bits. In the first exemplary embodiment, for simplification of illustration and understanding of the invention, the bias control signal ADJ[k−1:0] is a bias control signal ADJ[1:0] of 2 bits. For convenience, the symbol “OSCref” indicates the numerical value of a frequency but also the reference frequency signal generated by the reference oscillation circuit 220c. The configurations and operations of the level shifters LS1 and LS2 and the buffers Iv1 and Iv2 are similar to those in the first exemplary embodiment and will thus not be described below. Furthermore, the reference oscillation circuit 220c may be located in the source driver circuit 200 or outside the source driver circuit 200 so that the externally supplied reference frequency signal OSCref is input to the counter 220a.

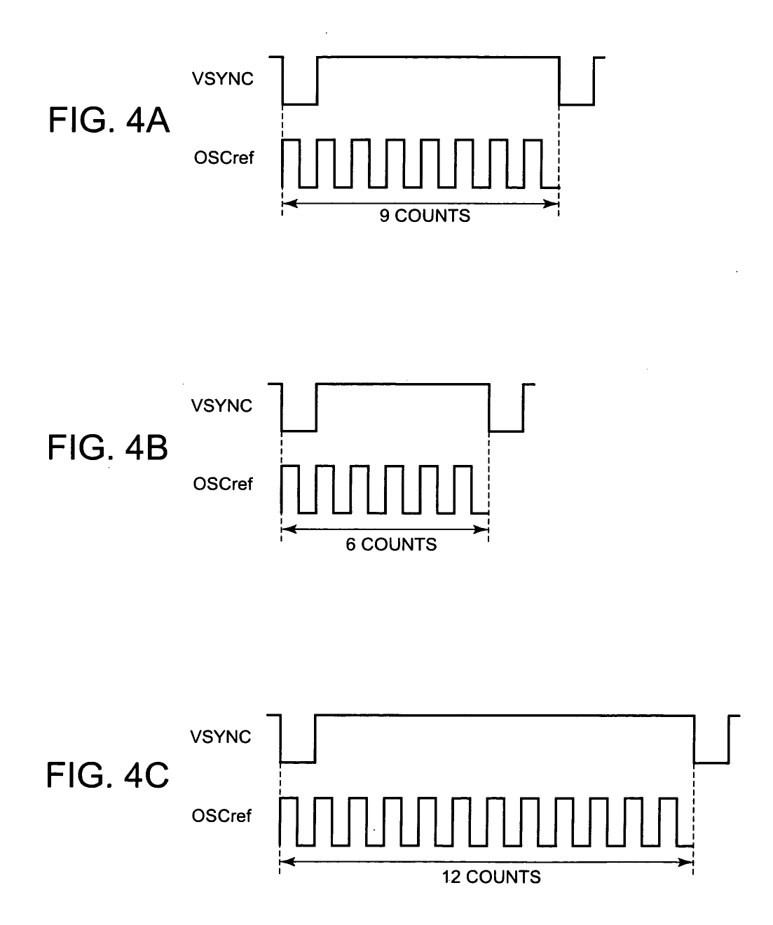

The operation of the source driver circuit 200 will be described below. However, the operations of the bias circuit 110 and source amplifier circuit 130 based on the bias control signal ADJ[1:0] are similar to those in the first exemplary embodiment and will thus not be described below. FIGS. 4A to 4C are schematic diagrams showing the relationship between the vertical synchronizing signal VSYNC and signal OSCref, input to the counter 220a.

First, the vertical synchronizing signal VSYNC from the cellular phone main body is input to the controller circuit 220 as a display signal. The counter 220a counts the period of the input vertical synchronizing signal VSYNC based on the reference frequency OSCref of the reference oscillation circuit 220c. For example, as shown in FIG. 4A, the counter 220a counts 9 when the frame frequency (the frequency of the vertical synchronizing signal VSYNC) is 60 Hz. As shown in FIG. 4B, the counter 220a counts 6 when the frame frequency is 90 Hz. As shown in FIG. 4C, the counter 220a counts 12 when the frame frequency is 40 Hz.

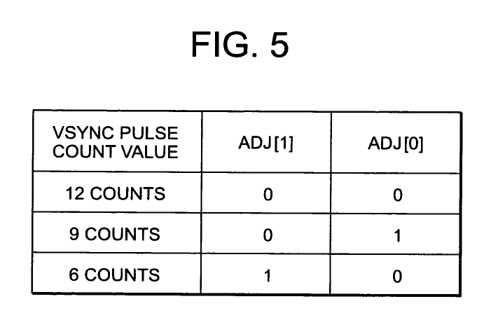

Then, the counter value from the counter 220a as described above is input to the decoder 220b. According to the count value, the decoder 220b generates a bias control signal ADJ[1:0] as shown the table in FIG. 5. The operations of the bias circuit 110 and source amplifier circuit 130 according to the ADJ[1:0] are similar to those in the first exemplary embodiment and will thus not be described below.

Thus, when the frame frequency of the liquid panel is changed, for example, from 60 Hz to 90 Hz, on the cellular phone main body side, the frequency of the vertical synchronizing signal VSYNC is also changed from 60 Hz to 90 Hz. This reduces the value of the reference frequency OSCref counted by the counter 220a and corresponding to the frequency of the vertical synchronizing signal VSYNC.

For example, as shown in FIG. 4A, when the vertical synchronizing signal VSYNC has a frequency of 60 Hz, the count value in the counter 220a is “9”. The count value “9” is input to the decoder 220b, which generates the bias control signal ADJ[1:0] of [01]. Here, when the frequency of the vertical synchronizing signal VSYNC is changed from 60 Hz to 90 Hz as described above, the count value in the counter 220a changes to “6”. Thus, the bias control signal ADJ[1:0] also changes to “10”. This increases the bias current I6 supplied to the amplifier AMP1. Consequently, the through rate of the amplifier AMP1 is set so as to be increased. In contrast, when the frequency of the vertical synchronizing signal VSYNC is changed from 90 Hz to 60 Hz as described above, the count value in the counter 220a changes from “6” to “9”. Thus, the bias control signal ADJ[1:0] changes from “10” to “01”. Consequently, the through rate of the amplifier AMP1 is set to be reduced.

As described above, if the frame frequency of the liquid crystal panel, that is, the frequency of the vertical synchronizing signal VSYNC, changes, then like the source driver circuit 100 according to the first exemplary embodiment, the source driver circuit 200 according to the second exemplary embodiment itself can automatically detect the change in frequency. Then, according to the result of the detection, the source driver circuit 200 can adjust the through rate and current consumption of the source amplifier 130 to the appropriate conditions. Furthermore, the cellular phone main body side does not particularly require, for example, a control circuit controlling the source driver circuit 200. Thus, also on the cellular phone main body side, the present configuration enables the number of steps of designing circuits, the scale of the circuits, the current consumption, and the like to be reduced.

### Third Exemplary Embodiment

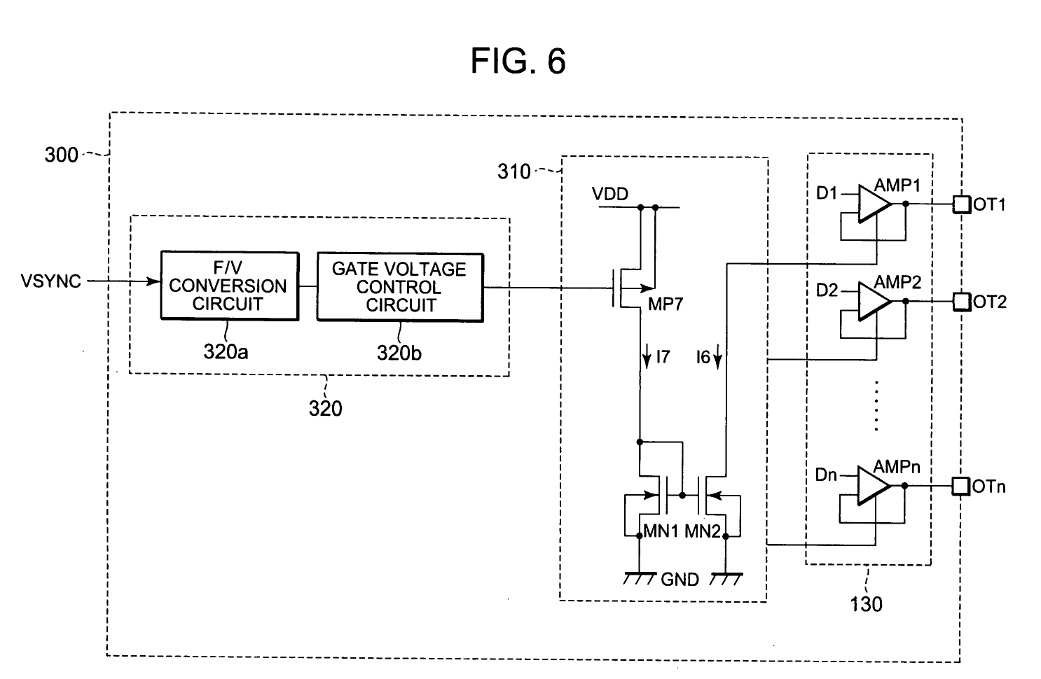

FIG. 6 shows an example of the configuration of a source driver circuit 300 according to a third exemplary embodiment. As shown in FIG. 6, the source driver circuit 300 has a bias circuit 310, a controller circuit 320, and a source amplifier circuit 130. The configuration and operation of the source amplifier circuit 130 are similar to those in the first exemplary embodiment and will not be described below.

The bias circuit 310 has a PMOS transistor MP7 and NMOS transistors MN1 and MN2. The PMOS transistor MP7 has a source connected to a power supply voltage terminal VDD, a drain connected to a node B, and a gate connected to the controller 320. A current flowing through the PMOS transistor MP7 is denoted by I7. Thus, the current I7 flowing through the PMOS transistor MP7 changes according to the level of a potential applied to the gate of the PMOS transistor MP7.

The NMOS transistor MN1 has a drain and a gate connected to the node B and a source connected to a ground voltage terminal GND. The NMOS transistor MN2 has a drain connected to an amplifier AMP1 of the source amplifier circuit 130, a source connected to the ground voltage terminal GND, and a gate connected to the node B. The NMOS transistors MN1 and MN2 serve as a current mirror circuit in which the NMOS transistor MN1 serves as an input. Here, the NMOS transistors MN1 and MN2 have the same gate length and the same gate width. Thus, when a current flowing through the NMOS transistor MN2 is denoted by I6, I7=I6. The current I6 is supplied as an operating bias current for the amplifier AMP1.

The controller circuit 320 has an F/V conversion circuit 320a and a gate voltage control circuit 320b.

Like the F/V conversion circuit 120a according to the first exemplary embodiment, the F/V conversion circuit 320a retrieves a vertical synchronizing signal (VSYNC) from a cellular phone main body side (not shown in the drawings). The F/V conversion circuit 320a then converts the frequency of the vertical synchronizing signal into a voltage level to output the resulting signal. According to the voltage level of the output signal from the F/V conversion circuit 320a, the gate voltage control circuit 320b controls the gate voltage of the PMOS transistor MP7.

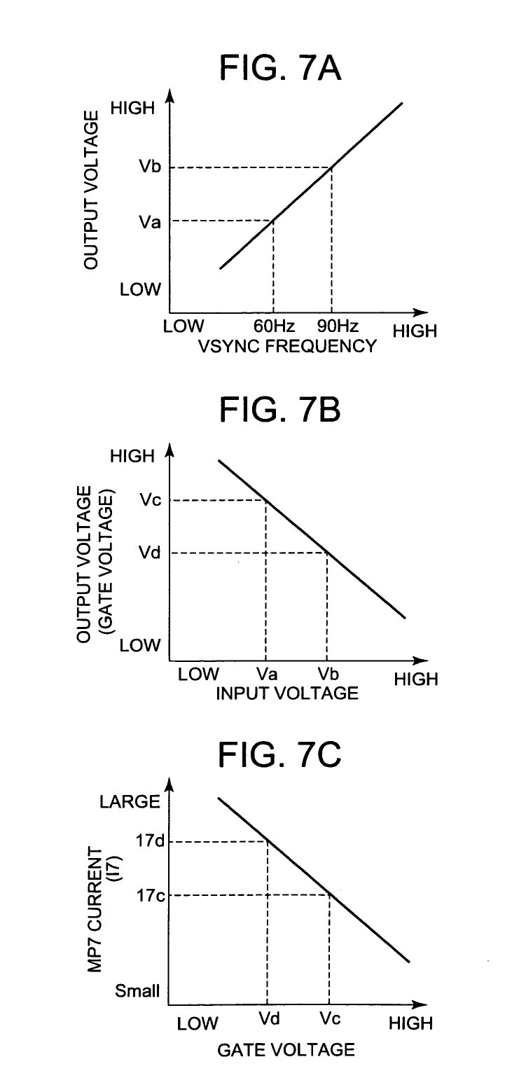

The operation of the source driver circuit 300 will be described below. FIG. 7A shows the relationship between the frequency of the input vertical synchronizing signal VSYNC to, and the output voltage from, the F/V conversion circuit 320a. FIG. 7B shows the relationship between the input voltage to the gate voltage control circuit 320b (the output voltage from the F/V conversion circuit 320a) and the gate voltage of the PMOS transistor MP7, to which an output from the gate voltage control circuit 320b is provided. FIG. 7C shows the relationship between the gate voltage of the PMOS transistor MP7 (the output voltage from the gate voltage control circuit 320b) and the current I7.

First, the vertical synchronizing signal VSYNC from the cellular phone main body is input to the controller circuit 320 as a display signal. The vertical synchronizing signal VSYNC is input to the F/V conversion circuit 320a. The F/V conversion circuit 320a outputs, for example, a voltage corresponding to the frequency of the vertical synchronizing signal VSYNC as shown in FIG. 7A.

The output voltage from the F/V conversion circuit 320a is input to the gate voltage control circuit 320b. According to the output voltage from the F/V conversion circuit 320a, the gate voltage control circuit 320b outputs, for example, the voltage shown in FIG. 7B, as the gate voltage of the PMOS transistor MP7.

The output voltage from the gate voltage control circuit 320b is input to the gate of the PMOS transistor MP7. According to the output voltage from the gate voltage control circuit 320b, for example, the current I7 shown in FIG. 7C flows between the source and drain of the PMOS transistor PM7.

Thus, when the frame frequency of the liquid crystal panel is changed, for example, from 60 Hz to 90 Hz, on the cellular phone main body side, the frequency of the vertical synchronizing signal VSYNC is also changed from 60 Hz to 90 Hz.

Consequently, the output voltage of the F/V conversion circuit 320a rises compared to that obtained at a frame frequency of 60 Hz.

For example, as shown in FIG. 7A, when the vertical synchronizing signal VSYNC has a frequency of 60 Hz, the F/V conversion circuit 320a outputs a voltage Va. The voltage Va is input to the gate control circuit 320b, which then applies an output voltage Vc to the gate of the PMOS transistor MP7. A current I7c corresponding to the voltage Vc flows through the PMOS transistor MP7.

Here, when the frequency of the vertical synchronizing signal VSYNC is changed from 60 Hz to 90 Hz as described above, the F/V conversion circuit 320a outputs a voltage Vb. The gate voltage control circuit 320b outputs a voltage Vd.

Moreover, the current flowing through the PMOS transistor MP7 in association with the voltage Vd as a gate voltage increases from 17c to 17d. The increased current I7 increases the bias current I6 supplied to the amplifier AMP1. Consequently, the through rate of the amplifier AMP1 is set to be increased.

In contrast, when the frequency of the vertical synchronizing signal VSYNC is changed from 90 Hz to 60 Hz, the output voltage from the F/V conversion circuit 320a decreases from Vb to Va. Thus, the output voltage from the gate voltage control circuit 320b changes to Vc. Moreover, the current flowing through the PMOS transistor MP7 in association with the voltage Vc as a gate voltage decreases from 17d to 17c. The reduced current I7 reduces the bias current I6 supplied to the amplifier AMP1. Consequently, the through rate of the amplifier AMP1 is set to be reduced.

As described above, if the frame frequency of the liquid crystal panel, that is, the frequency of the vertical synchronizing signal VSYNC, changes, then like the source driver circuit 100 according to the first exemplary embodiment, the source driver circuit 300 according to the third exemplary embodiment itself can automatically detect the change in frequency. Then, according to the result of the detection, the source driver circuit 300 can adjust the through rate and current consumption of the source amplifier 130 to the appropriate conditions. Compared to the first exemplary embodiment, the third exemplary embodiment is further advantageous in that the bias circuit can be simply configured. Furthermore, the cellular phone main body side does not particularly require, for example, a control circuit controlling the source driver circuit 300. Thus, also on the cellular phone main body side, the present configuration enables the number of steps of designing circuits, the scale of the circuits, the current consumption, and the like to be reduced.

The present invention is not limited to the above-described exemplary embodiments. Appropriate changes may be made to the exemplary embodiments without departing from the spirits of the present invention.

Further, it is noted that Applicant's intent is to encompass equivalents of all claim elements, even if amended later during prosecution.

What is claimed is:

1. A source driver circuit, comprising:
a bias circuit which supplies a bias current corresponding to a control signal;
a source amplifier circuit which supplies a voltage corresponding to the bias current to a pixel element in a display panel; and
a controller circuit which generates the control signal according to a frequency of a vertical synchronizing signal for the display panel.

2. The source driver circuit according to claim 1, wherein the controller circuit comprises:
a frequency-to-voltage conversion circuit which generates an output voltage corresponding to the frequency of the vertical synchronizing signal; and
an analog-to-digital conversion circuit which generates the control signal having a digital value of k (k being a natural number) bits corresponding to the output voltage,
wherein the bias circuit changes an amount of the bias current according to the control signal.

3. The source driver circuit according to claim 1, further comprising a reference frequency generating device generating a reference frequency,
wherein the controller circuit comprises:
a counter which counts a period of the reference frequency according to the frequency of the vertical synchronizing signal; and
a decoder which generates the control signal having a digital value of k (k being a natural number) bits corresponding to a count value in the counter,
wherein the bias circuit changes an amount of the bias current according to the control signal.

4. The source driver circuit according to claim 2, wherein the bias circuit comprises k transistors controlled between a conductive state or a nonconductive state depending on a value of each of the bits of the k-bit digital value, and
the amount of the bias current is changed according to a current value corresponding to a total of currents flowing through the k transistors.

5. The source driver circuit according to claim 1,
wherein the controller circuit comprises:
a frequency-to-voltage conversion circuit which generates a first output voltage corresponding to the frequency of the vertical synchronizing signal; and
a control voltage generation circuit which generates a second output voltage corresponding to the first output voltage,
wherein the bias circuit comprises a first transistor in which an amount of current flowing through the first transistor changes according to the second output voltage, in order to change an amount of the bias current according to the amount of current flowing through the first transistor.

6. The source driver circuit according to claim 1, wherein the control signal is generated according only to the frequency of the vertical synchronizing signal.

7. A method for controlling a source driver circuit including a bias circuit supplying a bias current, and a source amplifier circuit outputting a voltage corresponding to the bias current to a pixel element in a display panel, the method comprising:
changing an amount of the bias current according to a frequency of a vertical synchronizing signal for the display panel.

8. The method according to claim 7, further comprising:
generating an output voltage corresponding to the frequency of the vertical synchronizing signal;
generating a control signal having a digital value of k (k being a natural number) bits corresponding to the output voltage; and
changing an amount of the bias current according to the control signal.

9. The method according to claim 7, wherein the source driver circuit further comprises a reference frequency generating device generating a reference frequency, the method further comprising:
counting a period of the reference frequency according to the frequency of the vertical synchronizing signal; and
generating the control signal having a digital value of k (k being a natural number) bits corresponding to a count value in the counting; and
changing an amount of the bias current according to the control signal.

10. The method according to claim 7, wherein an amount of the bias current is changed according to an amount of current flowing through a transistor provided in the bias circuit, the method further comprising:
generating a first output voltage corresponding to the frequency of the vertical synchronizing signal;
generating a second output voltage corresponding to the first output voltage; and
changing the amount of current flowing through the first transistor according to the second output voltage.

11. The method according to claim 7, wherein the control signal is generated according only to the frequency of the vertical synchronizing signal.

12. A source driver circuit, comprising:
a frequency-to-voltage conversion circuit which is responsive to a frequency of a vertical synchronizing signal to generate an output voltage;
a voltage-to-current converter which converts the output voltage to a current; and
a source amplifier circuit which produces a voltage to be supplied to a pixel element in a display panel, in response to the current and an image data.

13. The source driver circuit as claimed in claim 12,
wherein the current is a first current;
wherein the frequency-to-voltage converter includes an analog-to-digital converter which converts the output voltage to a digital data; and
wherein the voltage-to-current converter includes a bias circuit which produces a second current based on the digital data; and
wherein the source driver circuit further includes a current mirror circuit which produces the first current based on the second current.

14. The source driver circuit as claimed in claim 12,
wherein the current is a first current;
wherein the frequency-to-voltage converter includes:
a counter which counts a number of cycles of a reference signal based on the vertical synchronizing signal; and
a decoder which outputs a digital data based on the number counted; and
wherein the voltage-to-current converter includes a bias circuit which produces a second current based on the digital data; and
wherein the source driver circuit further includes a current mirror circuit which produces the first current based on the second current.

15. The source driver circuit as claimed in claim 12,
wherein the current is a first current;
wherein the voltage-to-current converter includes a transistor which produces a second current based on the output voltage; and
wherein the source driver circuit further includes a current mirror circuit which produces the first current based on the second current.
